(19) United States
(12) Patent Application Publication
(10) Pub. No.: US 2008/0161960 A1
(43) Pub. Date: Jul. 3, 2008

(54) DEVICE FOR THE PRODUCTION OF PRINT PRODUCTS AND METHOD FOR THE CONTROL OF ITS DRIVES

(75) Inventor: Dieter Altenbach, Vordemwald (CH)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Muller Martini Holding AG, Hergiswil (CH)

(21) Appl. No.: 11/959,397

(22) Filed: Dec. 18, 2007

(30) Foreign Application Priority Data
Dec. 18, 2006 (DE) 102006059654.4

(51) Int. Cl. G06F 17/00

(52) U.S. Cl. 700/112

(57) ABSTRACT

To control a saddle stitcher, an inserting machine or the like, a data processing network (1) is provided in accordance with the present invention, whose nodes are formed by the motor control units (3₁, 3₂, 3₃, . . . , 3ₙ₋₁, 3ₙ). A coordinating node (2) provided in the network (1) sends out data frames serving for control purposes and receives data frames presenting status messages from the motor control units, on the basis of which it makes control decisions.

### BACKGROUND

The present invention relates to a method for the drive control of a device for the production of print products, which are composed of a multitude of partial products, which comprises a transport device transporting along a conveying path, a multitude of feeding devices corresponding to the multitude of partial products, from which the partial products are capable of being fed into the transport device at spots spaced apart from each other along the conveying path in a sequence corresponding to the print product, and a data processing network controlling the operations flow of the device, with the transport device and each of the feeding devices being equipped, respectively, with an electric drive motor and a motor control unit controlling the supply of electrical energy to the drive motor, each of which forms a node of the network which receives data frames from the network and sends data frames to the network, and the invention further relates to a device respectively suited for this purpose.

In a known method of this kind serving for the drive control of a saddle stitcher (EP 0 917 965 B1), the synchronous operation of the individual components of the saddle stitcher is ensured by a bidirectional exchange of messages taking place directly between the motor control units. In this constellation, each motor control unit has to have the ability to adequately react to the messages received by the other motor control units. If, for example, an error occurs in one of the motor control units, which is communicated in a message sent out by this motor control unit, the other motor control units have to decide whether the drive motors controlled by them have to be stopped.

### SUMMARY

The present invention is based on the technical problem of providing a method of a drive control that is simplified in comparison with the method mentioned above, and a device that is suited for this purpose.

In accordance with the invention, this task is solved with respect to the method in that the network comprises a coordinating node which receives data frames from the network and sends out data frames to the network, in that the coordinating node provides the data frames sent out by it with a piece of information, respectively, which identifies it as the sender and identifies one of the nodes forming the motor control units or all of these nodes as the receiver, in that each of the nodes forming a motor drive unit provides each of the data frames it sends out with one piece of information, respectively, which identifies it as the sender and identifies only the coordinating node as the receiver, in that each of the nodes receive only those data frames in which it is identified as the receiver, and in that each of the nodes forming a motor drive unit sends out data frames only when it was requested to do so by a data frame received.

Thus, in the design of the method in accordance with the invention, the coordinating node sends out data frames in which all other nodes forming a motor control unit or one of these nodes, respectively, are/is identified as the receiver of the data frame sent out. In this way, the data frame sent out by the coordinating node is received exclusively by the node or nodes identified therein as the receiver. The nodes forming the motor drive units only send out a data frame when they have received a data frame containing a send instruction from the coordinating node. They provide each of the data frames sent out with a piece of information, respectively, identifying them as the sender and exclusively identifying the coordinating node as the receiver. In this way, only the coordinating node assigns to the other nodes the right to send data frames.

At the same time, this ensures that the data frames sent out by the nodes forming the motor drive units are received exclusively by the coordinating node, which, on its part, sends out data frames which are received optionally by all or only one of the nodes forming the motor controls. Thus, by means of the data frames sent out by the coordinating node, the movement phases of the feeding devices may be coordinated with the movement phase of the transport device in such a way that the partial products are passed to the transport device in the correct position, making it possible for the partial products to be combined one after the other along the conveying path to form the intended print products. If, for example, a fault occurs at one of the nodes forming the motor control units, the node where the fault occurred will communicate this fault to the coordinating node by sending out a data frame in reaction to its data frames serving to cyclically poll all nodes. In reaction to the receipt of this data frame, the coordinating node then makes the decision, depending on the fault that was communicated, on the measures to be taken at the nodes forming the motor controls, and it will send out respective data frames which are received by the nodes forming the motor controls and which trigger the actions corresponding to the measures, in the simplest of cases, for example, a selective or complete shutdown of all drive motors.

Thus, given this basic principle in accordance with the present invention, the nodes forming the motor control units only send out such data frames in which the coordinating nodes are identified as the receiver, whereas the coordinating node is able to identify both a specific individual node, respectively, and all nodes as the receiver(s) in its data frames. This principle is modified in an advantageous embodiment in such a way that exactly one of the nodes forming the motor control units provides the data frames sent out by it with, electively, a piece of information which identifies all other nodes as the receiver.

This one node forming a motor control unit which is set off from the other nodes forming motor control units by having the specific feature enabling it to send data frames to all the other nodes, just like the coordinating node, may expediently serve as conductance transmitter in that, in these data frames sent to all other nodes, a piece of information corresponding to the rotation position of the respective drive motor is transmitted as the conductance value for the drive motors of all the other nodes. Advantageously, the node forming the motor control unit of the drive motor of the transport device is used as such a conductance transmitter.

In this specific embodiment as well, in which it is possible for both the coordinating node and exactly one special node forming a motor control unit to send out data frames to all the other nodes, there is no bidirectional data traffic between the nodes forming the motor control units. The special node only transmits unidirectional data frames, containing specifically a piece of conductance information, to the remaining nodes, which in turn transmit data frames exclusively to the coordinating node.

With respect to the device, the technical task which the invention is based on is solved by a device for the production of print products, composed of a multitude of partial products, comprising a transport device transporting along a conveying path, a multitude of feeding devices corresponding to the multitude of partial products, from which the partial products are capable of being fed into the transport device at spots spaced apart from each other along the conveying path in a sequence corresponding to the print product, and a data processing network controlling the operations flow of the device, with the transport device and each of the feeding devices being equipped, respectively, with an electric drive motor and a motor control unit controlling the supply of electrical energy to the drive motor, each of which forming a node of the network, from which data frames are capable of being received from the network and sent to the network. The network comprises a coordinating node, from which data frames are capable of being received from the network and being sent to the network. In the coordinating node and in each of the nodes forming the motor control units, there is a piece of information stored which uniquely identifies it within the network. The data frames sent out by the coordinating node are capable of being provided with a piece of information by the coordinating node which identifies it as the sender and identifies one of the nodes forming the motor control units or all of these nodes as the receiver(s). The data frames sent out by each of the nodes forming a motor control unit are capable of being provided with a piece of information by these nodes which identifies it as the sender and identifies only the coordinating node as the receiver. Each of the nodes is only capable of receiving such data frames which identify it as the receiver. Each of the nodes forming a motor control unit is capable of sending out data frames only upon receipt of a data frame containing a respective instruction to do so.

In this context, it is possible for the information identifying each node to operate through the respective hardware address of a network card provided in the respective motor control unit. The hardware addresses of known network cards are stored in the network cards and are unique in the sense that no network card has the same hardware address as another network card.

It is, however, expedient, to equip each motor control unit additionally with an encoding switch arrangement which allows for the manual setting of a specific node number. In this case, the coordinating node is able, when the device is ramping up, to identify the motor control units by their set node numbers and to request that the respectively identified node send out a data frame containing its hardware address to the coordinating node. In this way, the manual storage of the hardware addresses in the coordinating node is eliminated.

It is advantageous, both for the method and for the device, for the network to have a bus topology. In this case, all nodes of the network are located in the network leg formed by the bus.

The method for drive control in accordance with the present invention may be advantageously applied in a saddle stitcher in which the transport device is an assembly chain and the feeding devices are sheet feeders. Using the drive control in accordance with the invention, the drive motors of the assembly chain and of the sheet feeders are coordinated in such a way that a respective feeding device arranged downstream of the transport direction passes the sheets to the assembly chain in such a way that they come to lie on top of sheets passed from a feeding device arranged upstream of the transport direction and are thus capable of being collected in the known fashion from the inside to the outside.

As is well known, saddle stitchers generally include a stitching station arranged downstream from the feeding devices, where the collected sheets are stitched. In this case, it is advantageously provided that one of the nodes forming the motor drive units controls the drive motor of stitching station of the saddle stitcher.

Furthermore, the method in accordance with the present invention is suitable for the drive control of an inserting machine, in which the transport device is a pocket chain and the feeding devices are sheet feeders used to pass the partial products to the pockets. In this case as well, the drive control in accordance with the invention allows for the operation of the drive motors of the pocket chain and the sheet feeders to be coordinated in such a way that sheet feeders arranged downstream in the transport direction supply the additional partial products still required for the completely assembled print product to the pockets that have been supplied with partial products by the upstream sheet feeders.

In the event that there is a cutting station arranged downstream of one of these devices and serving to cut the pages of the assembled print product, it is also possible for a motor control unit controlling its drive motor to form a node of the data processing network and to be integrated into the drive control in accordance with the invention just like the other nodes forming motor drive units.

### BRIEF DESCRIPTION OF THE DRAWINGS

FIG. 1 schematically illustrates a data processing network, in accordance with various embodiments of the present invention.

### DETAILED DESCRIPTION

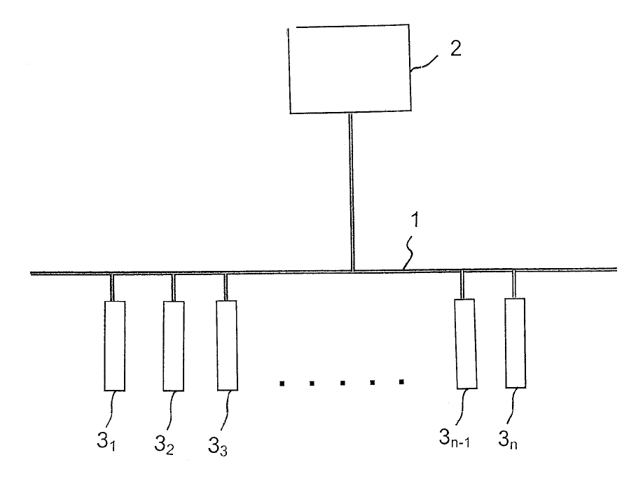

FIG. 1 schematically shows a data processing network exhibiting a bus topology, whose bus is designated with the reference number 1. A coordinating node 2 and n further nodes 3₁, 3₂, 3₃, . . . , 3ₙ₋₁, 3ₙ are coupled with the bus 1. For this purpose, the coordinating node 2 and each additional node 3₁, 3₂, 3₃, . . . , 3ₙ₋₁, 3ₙ each display a network card, in each of which a hardware address uniquely identifying the network card in the network is stored.

The network card of the coordinating node 2 serves as the interface for the data transmission between the bus 1 and an operating program running in the coordinating node 2. The network card of each of the additional nodes 3₁, 3₂, 3₃, . . . , 3ₙ₋₁, 3ₙ serves as the interface for the data transmission between the bus 1 and a motor control unit provided in each of these additional nodes, respectively.

Each network card comprises a sending/receiving device, which possibly is a known ethernet PHY, used to send data frames to the network and to receive data frames from the network. Furthermore, each network card is equipped with two ports and one HUB forwarding the data frames between the ports, so that adjacent nodes may be directly interconnected using daisy-chaining.

Each of the motor control units controls the electric energy supplied to an electric drive motor associated with it. One of these drive motors, for example, the drive motor controlled by the node 3ₙ₋₁, constitutes the main drive for a transport device transporting longitudinally along a conveying path, for example the rotating assembly chain of a saddle stitcher or the rotating pocket chain of an inserting machine. Each of the drive motors controlled by the nodes 3₁, 3₂, 3₃, . . . , 3ₙ₋₁, 3ₙ drives a respective feeder device used to feed partial print products of assembled print products to the transport device at spots spaced apart from each other along the conveying path. This type of forming assembled print products by means of assembly or insertion is generally known to those skilled in the art, which is why a more detailed explanation is dispensed with at this point.

The drive motor controlled by the remaining node 3ₙ illustrates, by way of example, the drive in the case of a stitching station provided in a saddle stitcher and/or a cutting station arranged downstream from the inserting machine.

Under the control of the operating program running within it, the coordinating node 2 sends data frames via its network card to the bus 1; in these data frames, it identifies itself as the sender of the data frame by specifying its hardware address. In each of these data frames sent out by it, it also identifies one of the other nodes 3₁, 3₂, 3₃, . . . , 3ₙ₋₁, 3ₙ as the receiver, by specifying its hardware address, or it identifies all of these nodes as the receiver by specifying a collective address set in the system.

The network cards of the nodes 3₁, 3₂, 3₃, . . . , 3ₙ₋₁, 3ₙ forming the motor control units check the receiver's addresses which are contained in the data frames issued on the bus 1. In the event that the receiver's address specified in the data frame does not correspond to the hardware address of the respective network card or the collective address, the network card blocks the receipt of this data frame.

When, due to the correspondence with the collective address or the individual hardware address of the respective node, the data frame is received, the network card forwards the information contained in the data frame to the motor drive unit associated with it. This information may be, for example, a reference value for the drive motor, sent out by the coordinating node 1 to the motor drive unit of the respective node 3₁, 3₂, 3₃, . . . , 3ₙ₋₁, 3ₙ, which, for example, causes the drive motor to assume a specific rotating position with respect to the rotating position of one of the other drive motors. But it could also be a request issued to this node to send out a data frame communicating a piece of status information of the motor control, which, for example, includes the current rotating position or an error status of the respective drive motor.

With the exception of the node 3ₙ₋₁ controlling the main drive, the network cards of the other nodes 3₁, 3₂, 3₃, . . . , 3ₙ₋₂, 3ₙ forming the motor control units may only specify the individual hardware addresses of the coordinating node 2 as the recipient's address, with the result that the data frames sent out by them are received only by the coordinating node 2. Only the node 3ₙ₋₁ controlling the main drive is capable of optionally providing the data frames sent out by it with the collective address as the receiver's address so that they can be received by all other nodes forming motor control units.

This makes it possible, in particular, for the main drive to communicate its current rotation position to all other drive motors as conductance. Just like all the other nodes forming motor control units, the node 3ₙ₋₁ associated with the main drive will send out data frames on the bus 1 only if it has been instructed to do so by data frames received from the coordinating node 2.

The operations flow set forth above assumes that the coordinating node 2 knows the hardware addresses of the network cards of all further nodes 3₁, 3₂, 3₃, . . . , 3ₙ₋₁, 3ₙ. For this reason, it is provided in the present embodiment being discussed that each network card is equipped with an encoding switch arrangement allowing the manual setting of a node number, for example, a two-digit hexadecimal node number. Then, when the system is booted up, the coordinating node 2 is able to poll the hardware address, associated with each node number, of the respective network card by sending out data frames containing the collective address as the receiver identification, and is able to thereby receive the address information required for the further operating flow.

1-13. (canceled)

14. A method for a drive control of a device for the production of print products composed of a multitude of partial products, the device comprising a transport device that transports along a conveying path, the device further comprising a multitude of feeding devices, corresponding to the multitude of partial products, from which the partial products are capable of being fed into the transport device at spots spaced apart from each other along the conveying path in a sequence corresponding to the print product, and the device further comprising a data processing network controlling the operations flow of the device, wherein the transport device and each of the feeding devices are equipped, respectively, with an electric drive motor and a motor control unit controlling the supply of electrical energy to the drive motor, each of which forms a node (3₁, 3₂, 3₃, . . . , 3ₙ₋₁, 3ₙ) of the network, from which data frames are received from the network and sent to the network, wherein the network comprises a coordinating node, the method comprising:
receiving, by the coordinating node, data frames from the network;
sending, by the coordinating node, data frames to the network;
providing, by the coordinating node, the data frames sent out by the coordinating node with a piece of information, respectively, identifying the coordinating node, as the sender and identifying one of the nodes forming the motor drive units or all of the nodes (3₁, 3₂, 3₃, . . . , 3ₙ₋₁, 3ₙ) as the receiver;
providing, by each of the nodes (3₁, 3₂, 3₃, . . . , 3ₙ₋₁, 3ₙ) forming a motor drive unit, each of the data frames sent out by each particular node with a piece of information, respectively, which identifies the particular node as the sender and only the coordinating node as the receiver;
wherein each of the nodes (3₁, 3₂, 3₃, . . . , 3ₙ₋₁, 3ₙ) receives only such data frames which identify it as the receiver; and
wherein each of the nodes (3₁, 3₂, 3₃, . . . , 3ₙ₋₁, 3ₙ) forming a motor control unit sends out data frames only upon receipt of a data frame containing a respective instruction to do so.

15. A method in accordance with claim 14, wherein exactly one of the nodes (3ₙ₋₁) forming the motor control units provides the data frames sent out by it selectively with a piece of information identifying all other nodes as receivers.

16. A method in accordance with claim 15, wherein exactly the one node (3ₙ₋₁) the motor control unit of the drive motor of the transport device and the data frames identifying all the other nodes as receivers contain a piece of information corresponding to the rotation position of this drive motor.

17. A method in accordance with claim 14, wherein the network exhibits a bus topology.

18. A device for the production of print products, composed of a multitude of partial products, the device comprising a transport device that transport along a conveying path, the device further comprising a multitude of feeding devices, corresponding to the multitude of partial products, from which the partial products are capable of being fed into the transport device at spots spaced apart from each other along the conveying path in a sequence corresponding to the print product, and the device further comprising a data processing network controlling the operations flow of the device, with the transport device and each of the feeding devices being equipped, respectively, with an electric drive motor and a motor control unit controlling the supply of electrical energy to the drive motor, each of which forming a node (3₁, 3₂, 3₃, . . . , 3ₙ₋₁, 3ₙ) of the network, from which data frames are received from the network and sent to the network, wherein the network comprises a coordinating node from which data frames are received from the network and are sent to the network, wherein in the coordinating node and in each of the nodes (3₁, 3₂, 3₃, . . . , 3ₙ₋₁, 3ₙ) forming the motor control units, there is a piece of information stored that uniquely identifies the particular node within the network storing the piece of information, wherein the data frames sent out by the coordinating node are provided with the piece of information by the coordinating node that identifies the coordinating node as the sender and identifies one of the nodes forming the motor control units or all of the nodes (3₁, 3₂, 3₃, . . . , 3ₙ₋₁, 3ₙ) as the receiver(s), wherein the data frames sent out by each of the nodes (3₁, 3₂, 3₃, . . . 3ₙ₋₁, 3ₙ) forming a motor control unit is provided with a piece of information by the node that identifies that particular as the sender and identifies only the coordinating node as the receiver, wherein each of the nodes (2, 3₁, 3₂, 3₃, . . . , 3ₙ₋₁, 3ₙ) is only capable of receiving such data frames that identify that particular node as the receiver, and wherein each of the nodes (3₁, 3₂, 3₃, . . . , 3ₙ₋₁, 3ₙ) forming a motor control unit is capable of sending out data frames only upon receipt of a data frame containing a respective instruction to do so.

19. A device in accordance with claim 18, wherein the data frames sent out by exactly one of the nodes (3ₙ₋₁) forming the motor control units are configured to be optionally provided by said node with a piece of information identifying all the other nodes as receivers.

20. A device in accordance with claim 19, wherein the precise one node (3ₙ₋₁) contains the motor control unit of the drive motor of the transport device and the data frames identifying all the other nodes as receivers contain a piece of information corresponding to the rotation position of this drive motor.

21. A device in accordance with claim 18, wherein the network exhibits a bus topology.

22. A device in accordance with claim 18, wherein each node comprises a network card with a hardware address uniquely identifying the network card in the network and a sending/receiving device serving to send and receive the data frames.

23. A device in accordance with claim 22, wherein each network card comprises two ports and one HUB serving to forward the data frames between the ports.

24. A device in accordance with claim 18, wherein the transport device is an assembly chain and the feeder devices are sheet feeders of a saddle stitcher.

25. A device in accordance with claim 24, wherein one of the nodes (3ₙ₋₁) forming the motor control units controls the drive motor of a stitching station of the saddle stitcher.

26. A device in accordance with claim 18, wherein the transport device is a pocket chain and the feeder devices are sheet feeders of an inserting machine.
